(19) United States
(12) Patent Application Publication
(10) Pub. No.: US 2016/0051928 A1
(43) Pub. Date: Feb. 25, 2016

(54) Delivery of a High Concentration Hydrogen Peroxide Gas Stream

(71) Applicant: RASIRC, INC., San Diego, CA (US)

(72) Inventors: Jeffrey J. SPIEGELMAN, San Diego, CA (US); Russell J. HOLMES, San Diego, CA (US); Bhuvnesh ARYA, San Diego, CA (US); Edward HEINLEIN, San Diego, CA (US); Daniel ALVAREZ, JR., Oceanside, CA (US)

(73) Assignee: RASIRC, Inc., San Diego, CA (US)

(21) Appl. No.: 14/781,615

(22) PCT Filed: Apr. 3, 2014
(86) PCT No.: PCT/US14/32748

§ 371 Date: Oct. 1, 2015

Related U.S. Application Data
(60) Provisional application No. 61/809,256, filed on Apr. 5, 2013.
(60) Provisional application No. 61/824,127, filed on May 16, 2013.

(51) Int. Cl. B01D 53/22; H05B 3/00; F22B 1/28

(52) U.S. Cl. CPC B01D 53/228; F22B 1/284; H05B 3/009

(57) ABSTRACT

A method and chemical delivery system are provided. The method includes providing a concentrated aqueous hydrogen peroxide solution in a boiler having a head space, boiling the concentrated aqueous hydrogen peroxide solution to produce a dilute vapor comprising hydrogen peroxide within the head space of the boiler, and adding a dilute aqueous hydrogen peroxide solution to the concentrated aqueous hydrogen peroxide solution within the boiler to maintain the concentration of the aqueous hydrogen peroxide solution in the boiler. The method further includes delivering the dilute vapor comprising hydrogen peroxide to a critical process or application. The chemical delivery system includes a concentrated aqueous hydrogen peroxide solution, a boiler having a head space configured for boiling the concentrated aqueous hydrogen peroxide solution and producing a dilute vapor comprising hydrogen peroxide within the head space, and a manifold configured for adding a dilute aqueous hydrogen peroxide solution to the concentrated aqueous hydrogen peroxide solution within the boiler to maintain the concentration of the aqueous hydrogen peroxide solution in the boiler, wherein the manifold is further configured to deliver the dilute vapor comprising hydrogen peroxide to a critical process or application.

This application claims priority to U.S. Provisional Application No. 61/809,256, filed on Apr. 5, 2013, and to U.S. Provisional Application No. 61/824,127, filed on May 16, 2013.

### TECHNICAL FIELD

Methods, systems, and devices for the vapor phase delivery of a high concentration high purity hydrogen peroxide gas stream for use in micro-electronics and other critical process applications.

### BACKGROUND

Various process gases may be used in the manufacturing and processing of micro-electronics. In addition, a variety of chemicals may be used in other environments demanding high purity gases, e.g., critical processes, including without limitation microelectronics applications, wafer cleaning, wafer bonding, photoresist stripping, silicon oxidation, surface passivation, photolithography mask cleaning, atomic layer deposition, chemical vapor deposition, flat panel displays, disinfection of surfaces contaminated with bacteria, viruses and other biological agents, industrial parts cleaning, pharmaceutical manufacturing, production of nano-materials, power generation and control devices, fuel cells, power transmission devices, and other applications in which process control and purity are critical considerations. In those processes, it is necessary to deliver specific amounts of certain process gases under controlled operating conditions, e.g., temperature, pressure, and flow rate.

For a variety of reasons, gas phase delivery of process chemicals is preferred to liquid phase delivery. For applications requiring low mass flow for process chemicals, liquid delivery of process chemicals is not accurate or clean enough. Gaseous delivery would be desired from a standpoint of ease of delivery, accuracy and purity. Gas flow devices are better attuned to precise control than liquid delivery devices. Additionally, micro-electronics applications and other critical processes typically have extensive gas handling systems that make gaseous delivery considerably easier than liquid delivery. One approach is to vaporize the process chemical component directly at or near the point of use. Vaporizing liquids provides a process that leaves heavy contaminants behind, thus purifying the process chemical. However, for safety, handling, stability, and/or purity reasons, many process gases are not amenable to direct vaporization.

There are numerous process gases used in micro-electronics applications and other critical processes. Ozone is a gas that is typically used to clean the surface of semiconductors (e.g., photoresist stripping) and as an oxidizing agent (e.g., forming oxide or hydroxide layers). One advantage of using ozone gas in micro-electronics applications and other critical processes, as opposed to prior liquid-based approaches, is that gases are able to access high aspect ratio features on a surface. For example, according to the International Technology Roadmap for Semiconductors (ITRS), current semiconductor processes should be compatible with a half-pitch as small as 20-22 nm. The next technology node for semiconductors is expected to have a half-pitch of 14-16 nm, and the ITRS calls for <10 nm half-pitch in the near future. At these dimensions, liquid-based chemical processing is not feasible because the surface tension of the process liquid prevents it from accessing the bottom of deep holes or channels and the corners of high aspect ratio features. Therefore, ozone gas has been used in some instances to overcome certain limitations of liquid-based processes because gases do not suffer from the same surface tension limitations. Plasma-based processes have also been employed to overcome certain limitations of liquid-based processes. However, ozone- and plasma-based processes present their own set of limitations, including, inter alia, cost of operation, insufficient process controls, undesired side reactions, and inefficient cleaning.

More recently, hydrogen peroxide has been explored as a replacement for ozone in certain applications. However, hydrogen peroxide has been of limited utility, because highly concentrated hydrogen peroxide solutions present serious safety and handling concerns and obtaining high concentrations of hydrogen peroxide in the gas phase has not been possible using existing technology. Hydrogen peroxide is typically available as an aqueous solution. In addition, because hydrogen peroxide has a relatively low vapor pressure (boiling point is approximately 150° C.), available methods and devices for delivering hydrogen peroxide generally do not provide hydrogen peroxide containing gas streams with a sufficient concentration of hydrogen peroxide. For vapor pressure and vapor composition studies of various hydrogen peroxide solutions, see, e.g., Hydrogen Peroxide, Walter C Schumb, Charles N. Satterfield and Ralph L. Wentworth, Reinhold Publishing Corporation, 1955, New York, available at http://hdl.handle.net/2027/mdp.39015003708784. Moreover, studies show that delivery into vacuum leads to even lower concentrations of hydrogen peroxide (see, e.g., Hydrogen Peroxide, Schumb, pp. 228-229). The vapor composition of a 30 H₂O₂ aqueous solution delivered using a vacuum at 30 mm Hg is predicted to yield approximately half as much hydrogen peroxide as would be expected for the same solution delivered at atmospheric pressure.

Gas phase delivery of low volatility compounds presents a particularly unique set of problems. One approach is to provide a multi-component liquid source wherein the process chemical is mixed with a more volatile solvent, such as water or an organic solvent (e.g., isopropanol). However, when a multi-component solution is the liquid source to be delivered (e.g., hydrogen peroxide and water), Raoult's Law for multi-component solutions becomes relevant. According to Raoult's Law, for an idealized two-component solution, the vapor pressure of the solution is equal to the weighted sum of the vapor pressures for a pure solution of each component, where the weights are the mole fractions of each component:

Pₜₒₜ=Pₐxₐ+P_{b}x_{b}

In the above equation, Pₜₒₜ is the total vapor pressure of the two-component solution, Pₐ is the vapor pressure of a pure solution of component A, xₐ is the mole fraction of component A in the two-component solution, P_{b} is the vapor pressure of a pure solution of component B, and x_{b} is the mole fraction of component B in the two-component solution. Therefore, the relative mole fraction of each component is different in the liquid phase than it is in the vapor phase above the liquid. Specifically, the more volatile component (i.e., the component with the higher vapor pressure) has a higher relative mole fraction in the gas phase than it has in the liquid phase. In addition, because the gas phase of a typical gas delivery device, such as a bubbler, is continuously being swept away by a carrier gas, the composition of the two-component liquid solution, and hence the gaseous head space above the liquid, is dynamic.

Thus, according to Raoult's Law, if a vacuum is pulled on the head space of a multi-component liquid solution or if a traditional bubbler or vaporizer is used to deliver the solution in the gas phase, the more volatile component of the liquid solution will be preferentially removed from the solution as compared to the less volatile component. This limits the concentration of the less volatile component that can be delivered in the gas phase. For instance, if a carrier gas is bubbled through a 30% hydrogen peroxide/water solution, only about 295 ppm of hydrogen peroxide will be delivered, the remainder being all water vapor (about 20,000 ppm) and the carrier gas.

The differential delivery rate that results when a multi-component liquid solution is used as the source of process gases make repeatable process control challenging. It is difficult to write process recipes around continuously changing mixtures. In addition, controls for measuring a continuously changing ratio of the components of the liquid source are not readily available, and if available, they are costly and difficult to integrate into the process. In addition, certain solutions become hazardous if the relative ratio of the components of the liquid source changes. For example, hydrogen peroxide in water becomes explosive at concentrations over about 75%; and thus, delivering hydrogen peroxide by bubbling a dry gas through an aqueous hydrogen peroxide solution, or evacuating the head space above such solution, can take a safe solution (e.g., 30% H₂O₂/H₂O) and convert it to a hazardous material that is over 75% hydrogen peroxide. Therefore, currently available delivery devices and methods are insufficient for consistently, precisely, and safely delivering controlled quantities of process gases in many micro-electronics applications and other critical processes.

Therefore, a technique is needed to overcome these limitations and, specifically, to allow vapor phase delivery of a sufficiently high concentration of high purity hydrogen peroxide to be used in a critical process application, such as microelectronics manufacturing.

### BRIEF DESCRIPTION OF CERTAIN EMBODIMENTS

Methods, systems, and device for delivering a high concentration hydrogen peroxide gas stream are provided. The methods, systems and devices are particularly useful in micro-electronics applications and other critical processes. One aspect of the present disclosure is directed to a method comprising providing a concentrated aqueous hydrogen peroxide solution in a boiler having a head space, boiling the concentrated aqueous hydrogen peroxide solution to produce a dilute vapor comprising hydrogen peroxide within the head space of the boiler, adding a dilute aqueous hydrogen peroxide solution to the concentrated aqueous hydrogen peroxide solution within the boiler to maintain the concentration of the aqueous hydrogen peroxide solution in the boiler, and delivering a consistent concentration of dilute vapor comprising hydrogen peroxide to a critical process or application.

In another embodiment, the concentrated aqueous hydrogen peroxide solution in the boiler is made in situ from the dilute aqueous hydrogen peroxide solution. In another embodiment, the method can further comprise removing contaminants from the dilute vapor by passing the dilute vapor through a purification assembly before delivering. In another embodiment, the purification assembly produces a condensate stream from the steam passing through. In another embodiment, the purification assembly comprises a plurality of membranes formed from a perfluorinated ion-exchange membrane. In another embodiment, the plurality of membranes are formed from NAFION® membrane. In another embodiment, boiling the aqueous hydrogen peroxide solution is accomplished by controlling the temperature of the concentrated aqueous hydrogen peroxide solution. In another embodiment, boiling the aqueous hydrogen peroxide solution is accomplished by controlling the pressure of the concentrated aqueous hydrogen peroxide solution. In another embodiment, boiling the aqueous hydrogen peroxide solution is accomplished by controlling the temperature and pressure of the concentrated aqueous hydrogen peroxide solution. In another embodiment, addition of the dilute aqueous hydrogen peroxide solution initiates when boiling begins. In another embodiment, the method further comprises adding a stabilizer that is non-volatile or rejected by the purification assembly, i.e., the stabilizer does not pass through the membrane.

Another aspect of the present disclosure is directed to a chemical delivery system comprising a concentrated aqueous hydrogen peroxide solution, a boiler having a head space configured for boiling the concentrated aqueous hydrogen peroxide solution and producing a dilute vapor comprising hydrogen peroxide within the head space, and a manifold configured for adding a dilute aqueous hydrogen peroxide solution to the concentrated aqueous hydrogen peroxide solution within the boiler to maintain the concentration of the dilute vapor comprising hydrogen peroxide. In addition, the chemical delivery system wherein the manifold is further configured to deliver the dilute vapor comprising hydrogen peroxide to a critical process or application.

In another embodiment, the concentrated aqueous hydrogen peroxide solution in the boiler is made in situ from the dilute aqueous hydrogen peroxide solution. In another embodiment, the manifold further comprises a purification assembly configured to remove contaminants from the dilute vapor. In another embodiment, the purification assembly comprises a plurality of membranes formed from a perfluorinated ion-exchange membrane. In another embodiment, the plurality of membranes are formed from NAFION® membrane. In another embodiment, the boiling of the concentrated aqueous hydrogen peroxide solution is controlled by a heat source and a thermocouple coupled to the boiler. In another embodiment, the boiling of the concentrated aqueous hydrogen peroxide solution is controlled by a pressure transducer and a control valve coupled to the boiler. In another embodiment, the boiling of the concentrated aqueous hydrogen peroxide solution is controlled by controlling the temperature of the aqueous hydrogen peroxide solution in the boiler and pressure of the head space in the boiler. In certain embodiments, the flow rate of the dilute vapor comprising hydrogen peroxide can be monitored by determining the energy used to heat the boiler solution, the change in pressure across an orifice, a combination of those monitoring methods, or any other suitable methods for monitoring gas flow in such systems. In another embodiment, the chemical delivery system can further comprise a stabilizer, which is added to the concentrated aqueous hydrogen peroxide solution, wherein the stabilizer is non-volatile or rejected by the purification assembly, i.e., the stabilizer does not pass through the membrane.

In certain embodiments, the hydrogen peroxide concentration in the dilute vapor is between 0.1% to 15% w/w. In certain embodiments, the hydrogen peroxide concentration in the dilute vapor is between 1% to 15% in mole fraction. In certain embodiments, the temperature of the concentrated aqueous hydrogen peroxide solution can be between 30° C. and 130° C. In another embodiment, the pressure of the dilute vapor comprising hydrogen peroxide delivered to the critical process or application is controlled by a downstream valve (e.g., a Teflon® valve) and delivered at a pressure of up to about 2000 Torr, between about 0.1 Torr to 2000 Torr, between about 1 Torr to 2000 Torr, between about 1 Torr and 1000 Torr. A valve downstream of the boiler or SPA can be configured according to the requirements of the applicable operating conditions to control the pressure, flow, and concentration of the hydrogen peroxide containing gas stream. In certain embodiments, a downstream valve prevents the mixing of the hydrogen peroxide containing gas stream with other process gases. An example of a valve that is useful for controlling the pressure, flow, and concentration of the hydrogen peroxide containing gas stream is a stepper controlled needle valve.

In certain embodiments, the methods, systems, and devices of the present invention deliver a vapor comprising hydrogen peroxide and steam without the use of a carrier gas. In certain other embodiments, the vapor comprising hydrogen peroxide and steam includes a carrier gas, e.g., an inert gas may be used to dilute the hydrogen peroxide containing gas stream. In certain other embodiments, the methods, systems, and devices of the present invention deliver hydrogen peroxide to processes at atmospheric or vacuum pressures by controlling the pressure through a valve (e.g., a Teflon® valve) downstream of the boiler or the SPA, where applicable. In certain other embodiments, any residual steam can be removed for the vapor comprising hydrogen peroxide prior delivering the hydrogen peroxide vapor to a critical process or application.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the embodiments and claims.

It is to be understood that both the foregoing general description and the following detailed description are exemplary and explanatory only and are not restrictive of the invention.

The accompanying drawings, which are incorporated in and constitute a part of this specification, illustrate several embodiments of the invention and, together with the description, serve to explain the principles of the invention.

### BRIEF DESCRIPTION OF THE DRAWINGS

FIG. 1 is a P&ID of a manifold that can be used to test methods, systems, and devices for H₂O₂ delivery according to certain embodiments of the present invention.

FIG. 2 is a P&ID of a manifold that can be used to test methods, systems, and devices for H₂O₂ delivery according to certain embodiments of the present invention.

FIG. 3 is a P&ID of a manifold that can be used to test methods, systems, and devices for H₂O₂ delivery according to certain embodiments of the present invention.

FIG. 4A is a chart showing the relationship between H₂O₂ concentration and density for 0-5 wt. % aqueous H₂O₂ solutions.

FIG. 4B is a chart showing the relationship between H₂O₂ concentration and density for 5-100 wt. % aqueous H₂O₂ solutions.

### DESCRIPTION OF CERTAIN EMBODIMENTS

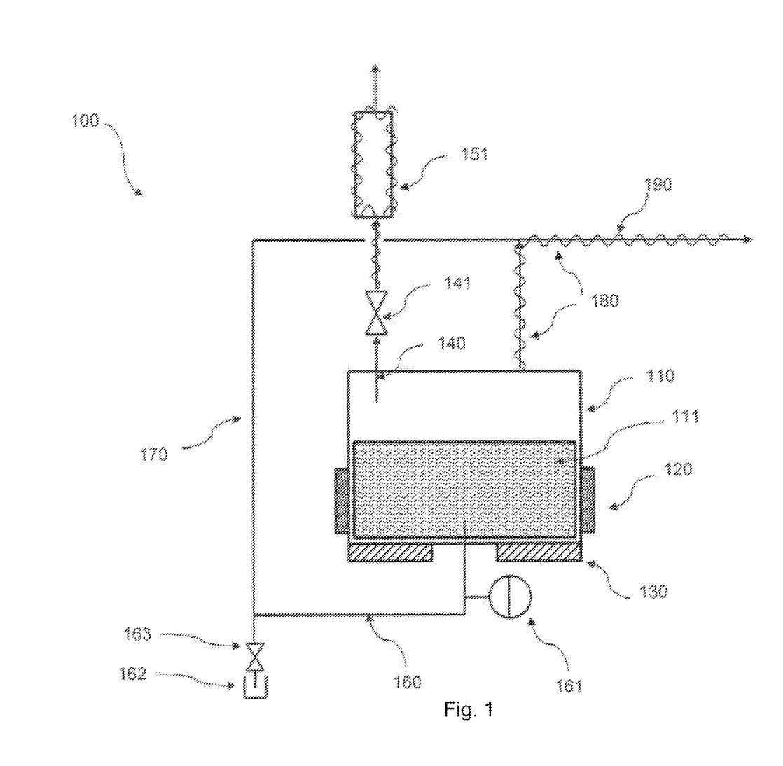

Embodiments of the methods, systems, and devices provided herein, in which steam can be used to deliver hydrogen peroxide, are shown by reference to FIGS. 1-3.

FIG. 1 depicts a test manifold 100. Manifold 100 can comprise a boiler 110 configured to contain a solution 111 and having a head space in a portion of the boiler 110. Boiler 110 can be a quartz boiler or formed of a like material that is compatible with the operating conditions. Manifold 100 can further comprise a band heater 120 (e.g., 1100 W heater band) and a lamp 130 (e.g., 800 W IR lamp) configured to heat solution 111 and cause a portion of solution 111 to vaporize. Manifold 100 can be formed of material that is compatible with operating conditions and peroxide solutions.

As shown in FIG. 1, connected to boiler 110 can be a pressure relief line 140 which can be in fluid communication with a valve 141. Valve 141 can be in fluid communication with a scrubber 151 (e.g., Carulite 200 4×8 catalyst scrubber). Valve 141 can be configured to be a pressure relief valve, which can open and release pressure from boiler 110 at a predetermined pressure set point to prevent over pressurization of boiler 110. Valve 141 can be made of PTFE. In addition, connected to boiler 110 can be a drain line 160, which can connect to an open drain 162. In fluid communication with drain line 160 and boiler 110 can be a thermocouple 161. Thermocouple 161 can detect the temperature of solution 111 in boiler 110. In addition, a controller (not shown) (e.g., Watlow EZ-Zone controller) can control band heater 120 and lamp 130 based on feedback from thermocouple 161. As shown in FIG. 1, also connected to drain 162 can be a level leg 170. Level leg 170 can be a ½″ PFA conduit configured to allow for visual determination of the level in boiler 110. A valve 163 can be positioned between drain 162 and level leg 170, and valve 163 can be configured to isolate drain 162.

In the upper portion of boiler 110 can be a discharge line 180 that allows vapor to exit from the head space of boiler 110 and exit manifold 100. Discharge line 180 can be in fluid communication with level leg 170, as shown in FIG. 1.

Discharge line 180 and scrubber 151 can be wrapped in a heat trace 190, which can generate heat and control the temperature of the vapor transported through the wrapped components. By controlling the temperature of the vapor, condensation of the vapor can be reduced or prevented.

### Example 1

Manifold 100, as shown in FIG. 1 was used to test delivery of H₂O₂ with steam. As part of the test, an initial volume of 950 ml of 30% H₂O₂ and 70% DI water (w/w) was boiled in boiler 110 for a period of 24 minutes. The temperature was maintained during the test between about 108-114° C. After 24 minutes, the final volume of solution in boiler 110 was 567 ml. Using a sample of the remaining solution the density was measured using an Antor Paar DMA 4100M Density Meter. Based on the density measurement the H₂O₂ concentration was calculated. For 0-5% solutions the equation used to calculate the concentration is shown below as equation 1.

$${H}_{2} {O}_{2} Conc . [ w \% ] = 276.49 \times Density [ \frac{g}{ml} ) - 275.57 \qquad ( 1 )$$

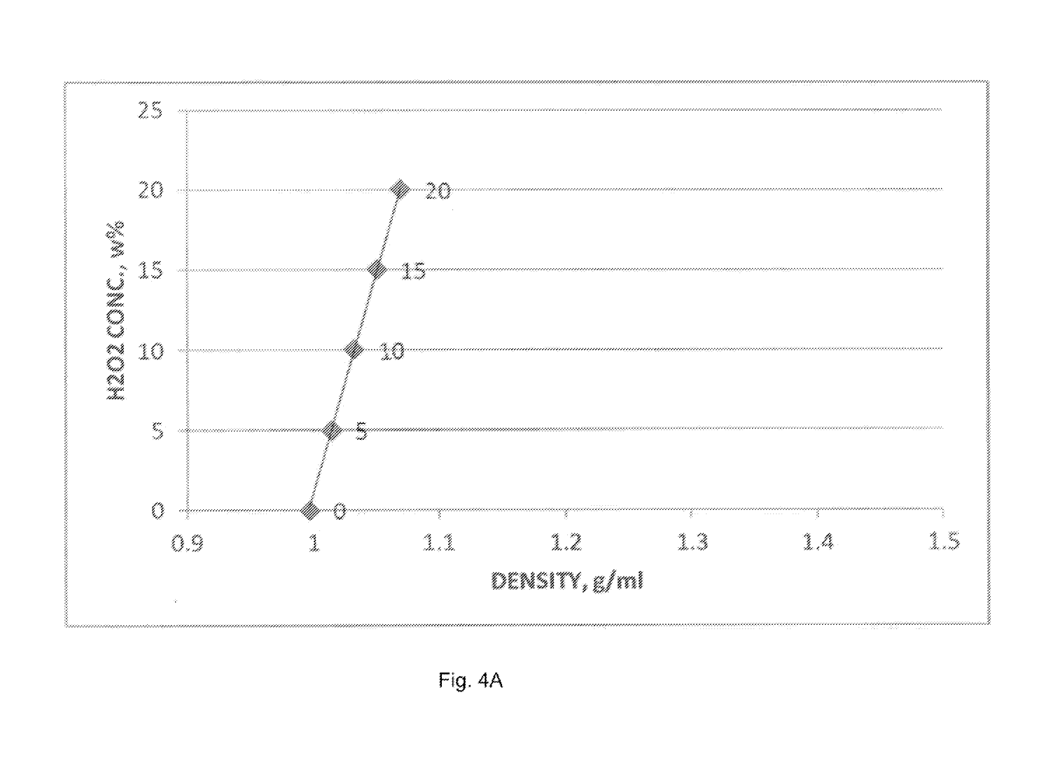

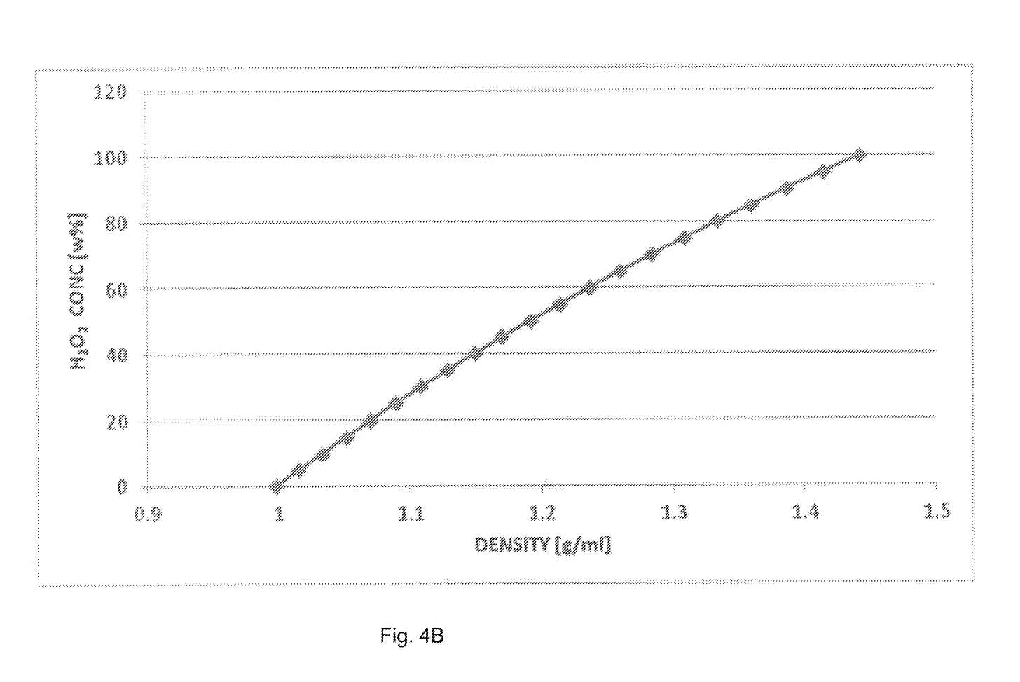

FIG. 4A is a chart showing the linear relationship between the concentration of H₂O₂ in a 0-5 wt. % aqueous H₂O₂ solution and the density of the solution, as described by equation 1. For 5-100 wt. % aqueous H₂O₂ solutions, the equation used to calculate the concentration is shown below as equation 2.

$${H}_{2} {O}_{2} Conc . [ w \% ] = 224.66 \times Density [ \frac{g}{ml} ) - 220 \qquad ( 2 )$$

FIG. 4B is a chart illustrating the linear relationship between the concentration of H₂O₂ in a 0-5 wt. % aqueous H₂O₂ solution and the density of the solution, as described by equation 2.

The final concentration of H₂O₂ was 41.4 wt. %. Based on these measurements the consumption rate and delivery rate for both the H₂O₂ and H₂O was calculated. The H₂O₂ consumption rate was about 1.29 ml/min and the H₂O consumption rate was about 14.6 ml/min. The H₂O₂ gas delivery rate was about 1.3 slm and the H₂O gas delivery rate was about 18.3 slm. These gas delivery rates are averaged based on the initial and final concentration of the solutions. Table 1 below shows some of the parameters and results of the test.

TABLE 1
No SPA, No Refill
Run Time: 24 Minutes
Boiler Temperature: 108-114° C.
Solution used 30% H2O2

| | | | Solution H₂O₂ | | |
|---|---|---|---|---|---|
| | | Solution | Concentration | | |
| | | Volume [ml] | [wt. %] | H₂O₂ [g] | H₂O₂ [ml] |
| Boiler | Initial | 950 | 30.2 | 316.5 | 218.32 |
| | Final | 567 | 41.4 | 269.34 | 185.75 |

| | | | |
|---|---|---|---|
| Boiler Solution | 383 | 47.16 | 32.57 |
| Consumed | | | |

| | |
|---|---|
| H₂O₂ Flow Rate [SLM] | 1.30 |

The data in Table 1 illustrates that the concentration of the solution can change in minutes without a refill solution, increasing 11.2 wt. % in 24 minutes. This rate of change can bring the concentration into a dangerous range within minutes.

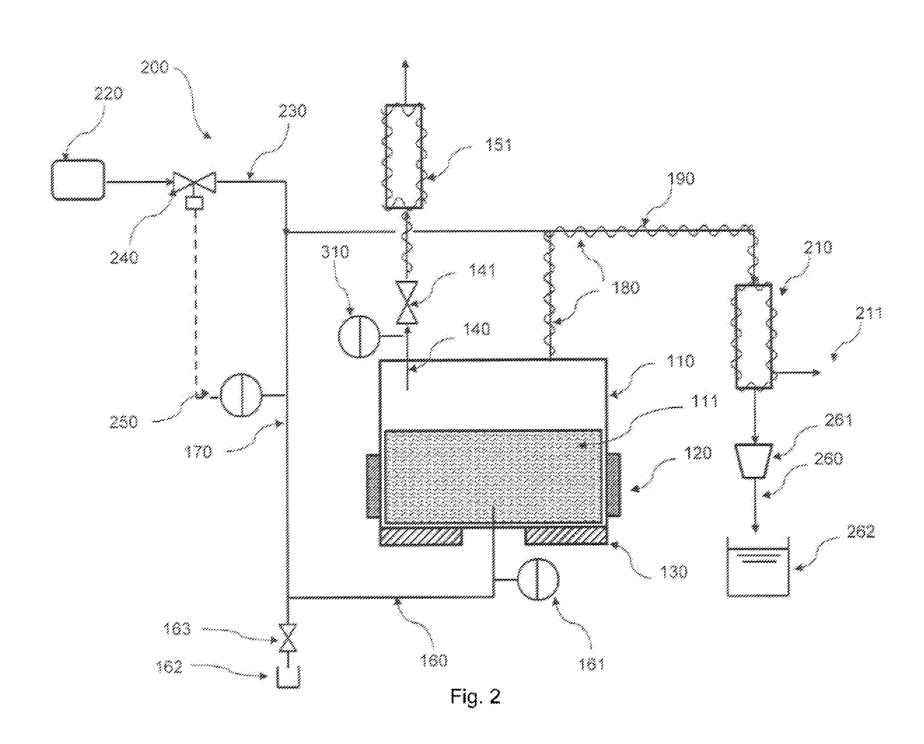

Another embodiment according to an aspect of the methods, systems, and devices provided herein is described below by reference to a manifold 200, as shown in FIG. 2. Manifold 200 can comprise all the components of manifold 100 as described above with reference to FIG. 1 along with additional components. Manifold 200 can comprise a purification assembly 210.

According to various embodiments, the purification assembly can be a membrane contactor that is compatible with the operating conditions. For example, the purification assembly can be a steam purification assembly (SPA) constructed similarly to the devices described in commonly assigned U.S. Pat. No. 8,287,708, which is herein incorporated by reference.

Purification assembly 210 can be located between discharge line 180 and process outlet 211 of manifold 200. Purification assembly 210 can comprise a plurality of membranes formed of, for example, a perfluorinated ion-exchange membrane, such as a NAFION® membrane. In certain embodiments, the membrane is an ion exchange membrane, such as a polymer containing exchangeable ions. Preferably, the ion exchange membrane is a fluorine-containing polymer, e.g., polyvinylidenefluoride, polytetrafluoroethylene (PTFE), ethylene tetrafluoride-propylene hexafluoride copolymers (FEP), ethylene tetrafluoride-perfluoroalkoxyethylene copolymers (PFE), polychlorotrifluoroethylene (PCTFE), ethylene tetrafluorideethylene copolymers (ETFE), polyvinylidene fluoride, polyvinyl fluoride, vinylidene fluoride-trifluorinated ethylene chloride copolymers, vinylidene fluoride-propylene hexafluoride copolymers, vinylidene fluoridepropylene hexafluoride-ethylene tetrafluoride terpolymers, ethylene tetrafluoride-propylene rubber, and fluorinated thermoplastic elastomers.

Manifold 200 can further comprise a refill supply 220, a refill line 230, a control valve 240, and a sensor 250. Refill supply 220 can be in fluid communication with control valve 240 and control valve 240 can be in fluid communication with refill line 230 and level leg 170. Sensor 250 can be located in level leg 170 and can be configured to detect the level of solution in level leg 170 or can simply detect the presence of solution at a specific level in level leg 170. Sensor 250 can be in communication with control valve 240 and based on a signal from sensor 250, control valve 240 can be positioned open, closed, or partially open (e.g., 1-99% open). Based on the position of control valve 240 additional refill supply 220 can be fed to level leg 170. Refill supply 220 can be pressurized. For example, nitrogen gas at 15-20 psig can be coupled to the refill supply 220 to pressurize the supply.

Manifold 200 can further comprise a condensate line 260, which can be in fluid communication with purification assembly 210. Condensate line 260 can be configured to discharge condensate from purification assembly 210 and pass the condensate through an orifice 261 and discharge the condensate into a container 262 configured to collect the condensate. Orifice 261 can be, for example, a 0.008″ sapphire orifice. In an alternate embodiment (not shown), condensate line 260 can be in fluid communication with a heated scrubber, which can be configured to eliminate the need for collection of the condensate.

Discharge line 180, scrubber 151, and purification assembly 210 can be wrapped in a heat trace 190, which can generate heat and can control the temperature of the vapor transported through the wrapped components. By controlling the temperature of the vapor, condensation of the vapor can be reduced or prevented.

### Example 2

Manifold 200, as shown in FIG. 2, was used to test delivery of H₂O₂ with steam including passing the hydrogen-peroxide containing gas stream through purification assembly 210, which was an SPA, as described above. In Example 2, there was no refilling of the solution by way of refill supply 220 to level leg 170, therefore valve 240 remained closed the duration of the test. As part of the test, an initial volume of 950 ml of 30% H₂O₂ and 70% DI water (w/w) was boiled in quartz boiler 110 for a period of 35 minutes. The temperature was maintained during the test between about 112-125° C. The temperature was maintained by controlling heat band 120 and lamp 130 based on readings from thermocouple 161.

After the 35 minutes, the final volume of solution in quartz boiler 110 was 785 ml. The final concentration of H₂O₂ was 33.08 wt. %. Based on these measurements the consumption rate and delivery rate for both the H₂O₂ and H₂O was calculated. The H₂O₂ consumption rate was about 0.49 ml/min and the H₂O consumption rate was about 4.2 ml/min. The H₂O₂ gas delivery rate was about 0.47 slm and the H₂O gas delivery rate was about 5.2 slm. These gas delivery rates are averaged based on the initial and final concentration of the solutions. As illustrated by the result of example 3 compared to example 2, the boiling point increased with the use of purification assembly 210 because of the pressure increase as a result of the back pressure created by purification assembly 210. In addition, delivery rate decreased with the use of purification assembly 210 in place. Furthermore, purification assembly 210 was compatible with the H₂O₂ steam, there were no ruptured membranes and no evidence of chemical degradation within purification assembly 210 as a result of the test.

Manifold 200 as described above can be used to deliver a process gas containing a hydrogen peroxide concentration as exhibited by Example 2 and Example 3. However, the duration of the tests were kept fairly short due to the loss in solution and the increase in H₂O₂ concentration within the boiler as a result of the tests, which can result in dangerous H₂O₂ concentrations in the liquid and/or gas phase. Accordingly, an advantage of the present disclosure is the ability to extend the duration of the test or operating time of the manifolds, up to a nearly continuous operation mode, by adding a dilute H₂O₂ solution to the concentrated H₂O₂ solution within the boiler during the test. Example 3 describes a test, according to certain embodiments of the methods and systems disclosed herein, in which a dilute H₂O₂ solution was added to manifold 200 during the test in an effort to maintain the concentration of the concentrated solution within boiler 110 resulting in a maintained drawing of dilute vapor from the head space within the boiler. Thus, the molar concentration of gaseous hydrogen peroxide delivered to a critical process is kept in balance by an equivalent feed of liquid hydrogen peroxide.

Optionally, manifold 200 can further comprise a pressure transducer 310 in fluid communication with pressure control line 140. Pressure transducer 310 can be a Teflon pressure transducer, a stainless steel pressure transducer, or the like. Pressure transducer 310 can be configured to read pressure in boiler 110. In addition, pressure transducer 310 can be in communication with valve 141 and together they can control the pressure within boiler 110 to a set point. Valve 141 can also be located before scrubber 151 to adjust for variable pressure downstream of the invention. Therefore, manifold 200 can be configured to control boiler 110 (i.e., boiling) by temperature same as manifold 100 or by pressure. In yet another embodiment, manifold 200 can be configured to control boiler 110 by both temperature and pressure. It is contemplated that the delivery pressure of the dilute solution can range from 20 torr to 2 barg.

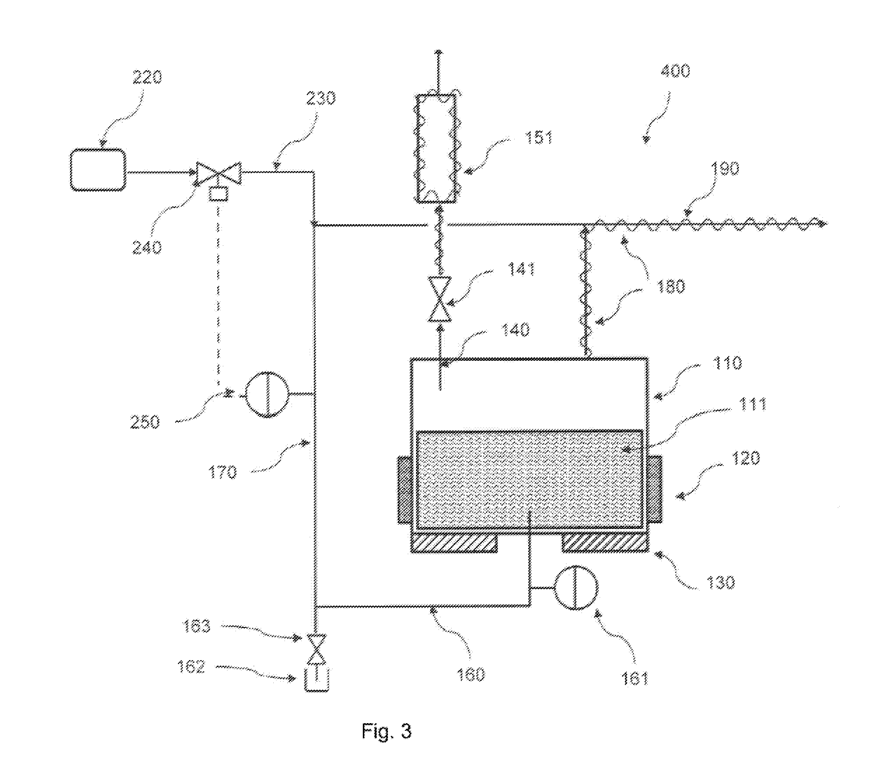

Another embodiment according to an aspect of the methods, systems, and devices provided herein is described below by reference to a manifold 400, as shown in FIG. 3. Manifold 400 can comprise all the components of manifold 100 as described above with reference to FIG. 1 along with some components described in regards to manifold 200. For example, in addition to all the components from manifold 100, manifold 400 can further comprise refill supply 220, refill line 230, control valve 240, and sensor 250. Manifold 400 can be configured to test that solution and vapor concentration within the boiler can be maintained by refilling boiler 110 with refill supply 220 having a proper concentration.

### Example 3

Manifold 400, as shown in FIG. 3, was used to test delivery of H₂O₂ with steam without passing the steam through purification assembly 210. As part of the test, an initial volume of 882 ml of 39.2% H₂O₂ and 60.8% DI water (w/w) was boiled in boiler 110 for a period of 35 minutes. The temperature was maintained during the test between about 113-115° C. The temperature was maintained by controlling heat band 120 and lamp 130 based on readings from thermocouple 161. During the test, refill supply 220 comprised a 9.9% H₂O₂ and 90.1% H₂O (w/w) solution at a pressure between 10-18 psig. The initial refill supply 220 volume was 531 ml.

After 35 minutes, the final concentration of H₂O₂ solution in boiler 110 was 40.8 wt. %. The final volume of the refill supply 220 was 67 ml. The H₂O₂ vapor delivery rate was calculated to be about 1.35 slm, based on Raoult's Law. Table 2 below shows some of the parameters and results of the test.

TABLE 2
With Refill but No SPA
Run Time: 35 Minutes
Boiler Temperature: 115° C.
Solution used 39.2% H2O2

| | | Solution | Solution | | |
|---|---|---|---|---|---|
| | | Volume | Concentration | | |
| | | [ml] | [%] | H₂O₂ [g] | H₂O₂ [ml] |
| Boiler | Initial | 882.4 | 39.2 | 393.81 | 271.59 |
| | Final | 791 | 40.8 | 369.51 | 254.83 |
| Boiler Solution | | 91.4 | | 24.3 | 16.76 |
| Consumed | | | | | |
| Refill | Initial | 531 | 9.89 | 54.179 | 37.365 |
| | Final | 67 | 9.89 | 6.836 | 4.715 |

| | | | |
|---|---|---|---|
| Refill Solution | 464 | 47.343 | 32.65 |
| Consumed | | | |
| Total H₂O₂ Output | | 71.643 | 49.41 |
| [Boiler Solution + | | | |
| Refill Solution] | | | |

| | |
|---|---|
| H₂O₂ Vapor Delivery Rate [SLM] | 1.35 |

Example 3 illustrates that a concentration of 39.2% H₂O₂ after 35 minutes increased only 1.6% to 40.8%. Accordingly, Example 3 illustrates that the H₂O₂ concentration can be substantially maintained and controlled utilizing the systems and methods of the present disclosure.

### Example 4

Manifold 200, as shown in FIG. 2, was used to test the delivery of H₂O₂ with steam including passing the hydrogen peroxide containing gas stream through purification assembly 210, which was an SPA, as described above. Two tests were performed for 35 minutes each. The first test was performed with a 20.4% aqueous H₂O₂ solution in the boiler and the second test was performed with a 44.5% aqueous H₂O₂ solution in the boiler.

The test parameters and results of the first test are shown below in Table 3.

TABLE 3
With 40 Lumen SPA and Refill
Run Time: 35 Minutes
Boiler Temperature: 112° C.
Solution used: 20.4% H2O2

| | | Solution | Solution H₂O₂ | | |
|---|---|---|---|---|---|
| | | Volume | Concentration | | |
| | | [ml] | [wt. %] | H₂O₂ [g] | H₂O₂ [ml] |
| Boiler | Initial | 882 | 20.4 | 192.08 | 132.47 |
| | Final | 843 | 21.5 | 194.2 | 133.93 |
| Boiler Solution | | 39 | | −2.12 | −1.46 |
| Consumed | | | | | |
| Refill | Initial | 494 | 5.3 | 26.62 | 18.359 |
| | Final | 100 | 5.3 | 5.389 | 3.716 |
| Refill Solution | | 394 | | 21.231 | 14.643 |
| Consumed | | | | | |
| Condensate | Initial | 100 | 0 | 0 | 0 |
| | Final | 128 | 0.89 | 1.142 | 0.788 |

| | | | | |
|---|---|---|---|---|
| Condensate Output | 28 | 4 | 1.142 | 0.788 |
| Total H₂O₂ Output | | | 17.969 | 12.395 |
| [Boiler Solution + | | | | |
| Refill Solution + | | | | |
| Condensate Output] | | | | |

| | |
|---|---|
| H₂O₂ Vapor Delivery Rate [SLM] | 0.34 |

The H₂O₂ vapor delivery rate for the first test was calculated to be about 0.34 slm, based on Raoult's Law.

The tests parameters and results of the second test are shown below in Table 4.

TABLE 4
With 40 Lumen SPA and Refill
Run Time: 35 Minutes
Boiler Temperature: 124° C.
Solution used: 44.5% H2O2

| | | Solution | Solution H₂O₂ | | |
|---|---|---|---|---|---|
| | | Volume | Concentration | | |
| | | [ml] | [%] | H₂O₂ [g] | H₂O₂ [ml] |
| Boiler | Initial | 871.5 | 44.5 | 449.958 | 310.316 |
| | Final | 780.6 | 45.3 | 411.457 | 293.763 |
| Boiler Solution | | 90.9 | | 38.501 | 16.553 |
| Consumed | | | | | |
| Refill | Initial | 990 | 10 | 102.171 | 70.463 |
| | Final | 795 | 10 | 82.046 | 56.584 |
| Refill Solution | | 195 | | 20.125 | 13.879 |
| Consumed | | | | | |
| Condensate | Initial | 100 | 0 | 0 | 0 |
| | Final | 132 | 2.36 | 3.138 | 2.164 |

| | | | | |
|---|---|---|---|---|
| Condensate Output | 32 | 9.5 | 3.138 | 2.164 |
| Total H₂O₂ Output | | | 55.488 | 28.268 |
| [Boiler Solution + | | | | |
| Refill Solution + | | | | |
| Condensate Output] | | | | |

| | |
|---|---|
| H₂O₂ Vapor Delivery Rate [SLM] | 0.77 |

The H₂O₂ vapor delivery rate was calculated to be about 0.77 slm, based on Raoult's Law.

Examples 1-4 demonstrate that the total H₂O₂ output of a system according to an aspect of the present invention can be matched with the appropriate refill solution concentration to maintain the solution concentration in the boiler and the H₂O₂ vapor delivery rate. Table 6 shows the range of refill solutions required for the aqueous H₂O₂ boiler solutions of different wt. % H₂O₂ at 50° C. and 130° C.

TABLE 6

| Boiler Solution | Refill Solution Conc w/w | Refill Solution Conc w/w |
|---|---|---|
| Conc w/w (%) | for 50° C. (%) | for 130° C. (%) |
| 20 | 1.1 | 2.4 |
| 30 | 2.2 | 4.7 |
| 40 | 4.1 | 8.0 |
| 50 | 7.4 | 13.2 |
| 60 | 13.1 | 21.4 |

The refill concentration was calculated using the equations found in “Hydrogen Peroxide” by Schumb, Satterfield, and Wentworth (1995), which is incorporated herein by reference.

According to various embodiments, the boiler can be a quartz boiler and the various components of the manifold can be made of materials that are compatible with the operating conditions, for example, stainless steel, PFA, or PTFE. Such materials can aid in production of higher purity process gas.

According to various embodiments, a stabilizer can be added to the solution within the boiler that is non-volatile or rejected by the membrane, i.e., the stabilizer does not pass through the membrane. Adding the stabilizer can increase the safety of the method and process.

According to another embodiment, a dilute H₂O₂/H₂O solution can be introduced into the boiler and the dilute solution can be boiled down to form the concentrated solution. Once reaching the concentrated solution any additional loss can be replenished by adding additional dilute H₂O₂ solution to make up for the vapor lost to the boiler head space. Accordingly, this can deliver dilute vapor of H₂O₂ and steam. This method allows for the concentrated hydrogen peroxide solution in the boiler to be made in situ from the dilute aqueous hydrogen peroxide solution. This can allow for consistent delivery of steam with H₂O₂ vapor by using the dilute solution feed to balance the vapor phase head space within the boiler.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method comprising:
(a) providing a concentrated aqueous hydrogen peroxide solution in a boiler having a head space;
(b) boiling the concentrated aqueous hydrogen peroxide solution to produce a dilute vapor comprising hydrogen peroxide within the head space of the boiler;
(c) adding a dilute aqueous hydrogen peroxide solution to the concentrated aqueous hydrogen peroxide solution within the boiler to maintain the concentration of the aqueous hydrogen peroxide solution in the boiler; and
(d) delivering the dilute vapor comprising hydrogen peroxide to a critical process or application.

2. The method of claim 1, wherein the concentrated aqueous hydrogen peroxide solution in the boiler is made in situ from the dilute aqueous hydrogen peroxide solution.

3. The method of claim 1, further comprising removing contaminants from the dilute vapor by passing the dilute vapor through a purification assembly before delivering.

4. The method of claim 3, wherein the purification assembly comprises a plurality of membranes formed from a perfluorinated ion-exchange membrane.

5. The method of claim 4, wherein the plurality of membranes are formed from NAFION® membrane.

6. The method of claim 3, wherein the purification assembly comprises a steam purification assembly.

7. The method of claim 1, wherein boiling the aqueous hydrogen peroxide solution is accomplished by controlling the temperature of the concentrated aqueous hydrogen peroxide solution.

8. The method of claim 1, wherein boiling the aqueous hydrogen peroxide solution is accomplished by controlling the pressure in the head space of the boiler.

9. The method of claim 1, wherein boiling the aqueous hydrogen peroxide solution is accomplished by controlling the temperature of the concentrated aqueous hydrogen peroxide solution and the pressure in the head space of the boiler.

10. The method of claim 1, wherein addition of the dilute aqueous hydrogen peroxide solution initiates when boiling begins.

11. The method of claim 1, further comprising adding a stabilizer that is non-volatile or rejected by the purification assembly.

12. The method of claim 1, wherein the dilute vapor comprising the hydrogen peroxide is delivered with a carrier gas.

13. The method of claim 1, wherein the dilute vapor comprising the hydrogen peroxide is delivered without the use of a carrier gas.

14. The method of claim 1, wherein the hydrogen peroxide concentration in the dilute vapor is between 0.1% to 15% w/w.

15. The method of claim 1, wherein the hydrogen peroxide concentration in the dilute vapor is between 1% to 15% in mole fraction.

16. The method of claim 1, wherein the temperature of the concentrated aqueous hydrogen peroxide solution can be between 30° C. and 130° C.

17. The method of claim 1, wherein the pressure of the dilute vapor comprising hydrogen peroxide is controlled by a downstream valve and delivered at a pressure between 0.1 Torr to 2000 Torr.

18. A chemical delivery system comprising:
(a) a concentrated aqueous hydrogen peroxide solution;
(b) a boiler having a head space configured for boiling the concentrated aqueous hydrogen peroxide solution and producing a dilute vapor comprising hydrogen peroxide within the head space; and
(c) a manifold configured for adding a dilute aqueous hydrogen peroxide solution to the concentrated aqueous hydrogen peroxide solution within the boiler to maintain the concentration of the aqueous hydrogen peroxide solution in the boiler;
wherein the manifold is further configured to deliver the dilute vapor comprising hydrogen peroxide to a critical process or application.

19. The chemical delivery system of claim 18, wherein the concentrated aqueous hydrogen peroxide solution in the boiler is made in situ from the dilute aqueous hydrogen peroxide solution.

20. The chemical delivery system of claim 18, wherein the manifold further comprises a purification assembly configured to remove contaminants from the dilute vapor.

21. The chemical delivery system of claim 20, wherein the purification assembly comprises a plurality of membranes formed from a perfluorinated ion-exchange membrane.

22. The chemical delivery system of claim 21, wherein the plurality of membranes are formed from NAFION® membrane.

23. The chemical delivery system of claim 20, wherein the purification assembly comprises a steam purification assembly.

24. The chemical delivery system of claim 18, wherein the boiling of the concentrated aqueous hydrogen peroxide solution is controlled by a heat source and a thermocouple coupled to the boiler.

25. The chemical delivery system of claim 18, wherein the boiling of the concentrated aqueous hydrogen peroxide solution is controlled by a pressure transducer and a control valve coupled to the boiler.

26. The chemical delivery system of claim 18, wherein the boiling of the concentrated aqueous hydrogen peroxide solution is controlled by controlling the temperature of the aqueous hydrogen peroxide solution in the boiler and the pressure in the head space of the boiler.

27. The chemical delivery system of claim 18, further comprising a stabilizer, which is added to the concentrated aqueous hydrogen peroxide solution, wherein the stabilizer is non-volatile or rejected by the purification assembly.

28. The chemical delivery system of claim 18, wherein the dilute vapor comprising hydrogen peroxide further comprises a carrier gas.

29. The chemical delivery system of claim 18, wherein the dilute vapor comprising hydrogen peroxide is delivered without the use of a carrier gas.

30. The chemical delivery system of claim 18, wherein the hydrogen peroxide concentration in the dilute vapor is between 0.1% to 15% w/w.

31. The chemical delivery system of claim 18, wherein the hydrogen peroxide concentration in the dilute vapor is between 1% to 15% in mole fraction.

32. The chemical delivery system of claim 18, wherein the temperature of the concentrated aqueous hydrogen peroxide solution can be between 30° C. and 130° C.

33. The chemical delivery system of claim 18, wherein the pressure of the dilute vapor comprising hydrogen peroxide is controlled by a downstream valve and delivered at a pressure between 0.1 Torr to 2000 Torr.
